(19) United States
(12) Patent Application Publication
(10) Pub. No.: US 2017/0228818 A1
(43) Pub. Date: Aug. 10, 2017

(54) Method, medium, and system for the education about, gathering of, and transmission of information and documents for application to rent living accommodations

(71) Applicant: Ryan Edward Barone, Hollis, NY (US)

(72) Inventor: Ryan Edward Barone, Hollis, NY (US)

(21) Appl. No.: 15/442,620

(22) Filed: Feb. 24, 2017

(51) Int. Cl. G06Q 30/06; G06Q 10/10; H04L 12/58

(52) U.S. Cl. CPC G06Q 30/0645; H04L 51/08; G06Q 10/10

(57) ABSTRACT

Consumers that are interested in renting properties can gather all of the information and documents necessary to provide to a property owner in order to rent a given property, prior to the viewing a particular property. The implementation of a system could be such that consumers could send this gathered information and documents to property managers prior to viewing a property as well as once the property has been viewed. By providing property managers with information prior to viewings of the property, the system allows property managers to pre-screen tenants. By providing property managers with information following viewings of properties, the system allows property managers to receive expedited information to process and provide approval or rejection of a consumer.

### FIELD OF THE DISCLOSURE

The invention disclosed herein relates to streamlining the rental process for living accommodations. Specifically, the system and method relate to the education, gathering, end transmission of information and documents for application to rent living accommodations.

### DESCRIPTION OF THE RELATED ART

Methods and systems that relate to improving the rental process for living accommodations and reducing inefficiencies do exist. Some methods and systems, referred herein as “listing services” and “real estate marketing services,” incorporate computing mediums to list available living accommodations on the internet to facilitate the marketing of available living accommodations to prospective renters and to notify landlords and agents. Other methods and systems, referred herein as “property management software,” currently enable landlords, management companies, and the similar parties to receive applications for available living accommodations and view such applications in a single or multiple computing interfaces.

### SUMMARY

The technology discussed within this disclosure can be used to allow a consumer to compile information and documents needed for the rental process prior to viewing a potential living accommodation and to then transmit the information and documents to a designated landlord, agent, individual, or party of the consumer's choosing. Using the disclosed invention, potential renters could learn about what the information and documents are needed to rent an apartment, why the information and documents are needed, and how to collect the information and documents. Additionally, the systems and methods disclosed could enable potential renters to collect the information and documents needed to rent and to persistently store the information and documents within a local database on the users' device and/or on servers, and/or to facilitate sending such information to a designated landlord, agent, party, or other individual. By using the technology disclosed, a consumer would be able to compile the information and documents to create a rental packet that could be transmitted to one or more landlords/agents. After transmitting the packet the landlord's/agents may approve the consumer for an apartment. Examples, drawings, and/or descriptions of the technology are described here but should not limit the application of the system. Similarly, the terminology used in this disclosure is be used for sake of convenience and description, and such terminology does not imply limitations or requirements regarding the setup of a particular architecture. Phrasing, terminology, and the detailed description itself is provided for the sake of illustrations and should be understood with their broadest interpretation and meaning, encompassing equivalents of the aspects described herein.

### DESCRIPTION OF THE INVENTION

To provide a further understanding of the invention disclosed herein and not to limit the scope of the invention, the drawings and detailed descriptions are provided as follows:

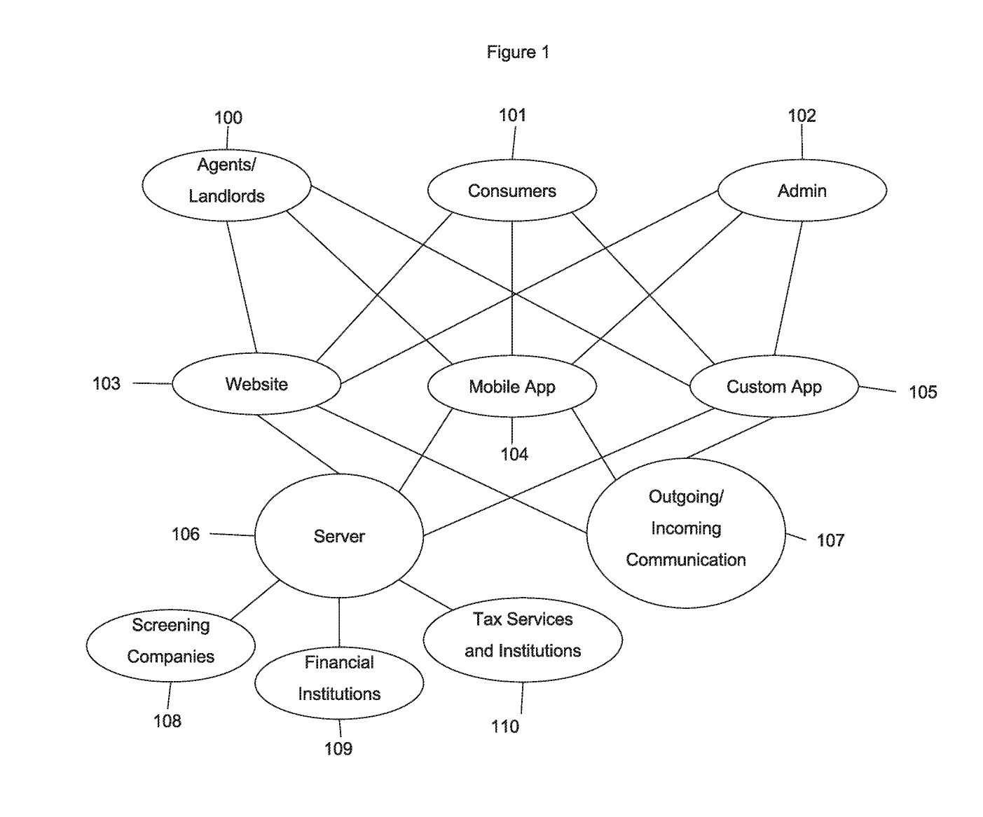

FIG. 1 is an illustrative block diagram of a system architecture which can be used to implement illustrative aspects disclosed in the technology described herein.

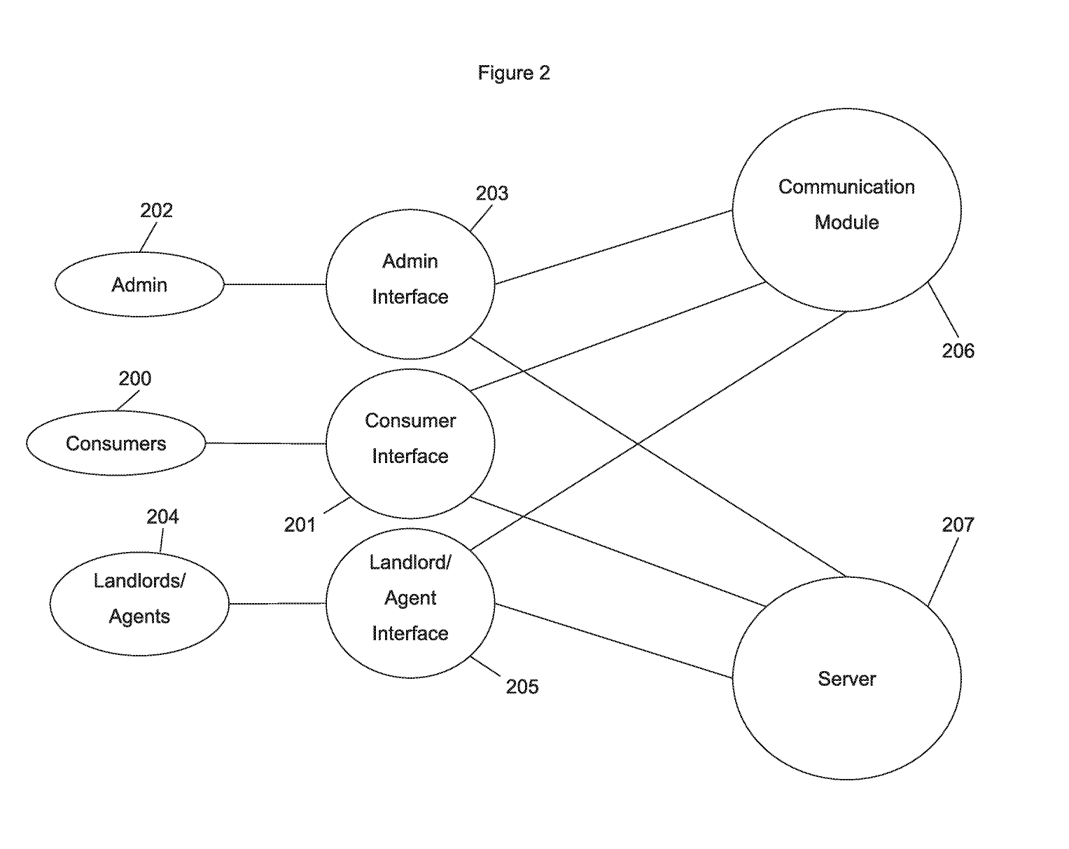

FIG. 2 is an illustrative block diagram of an interface architecture for a system that can be used for a consumer to compile information and documents needed for the rental process and transmit such information and documents.

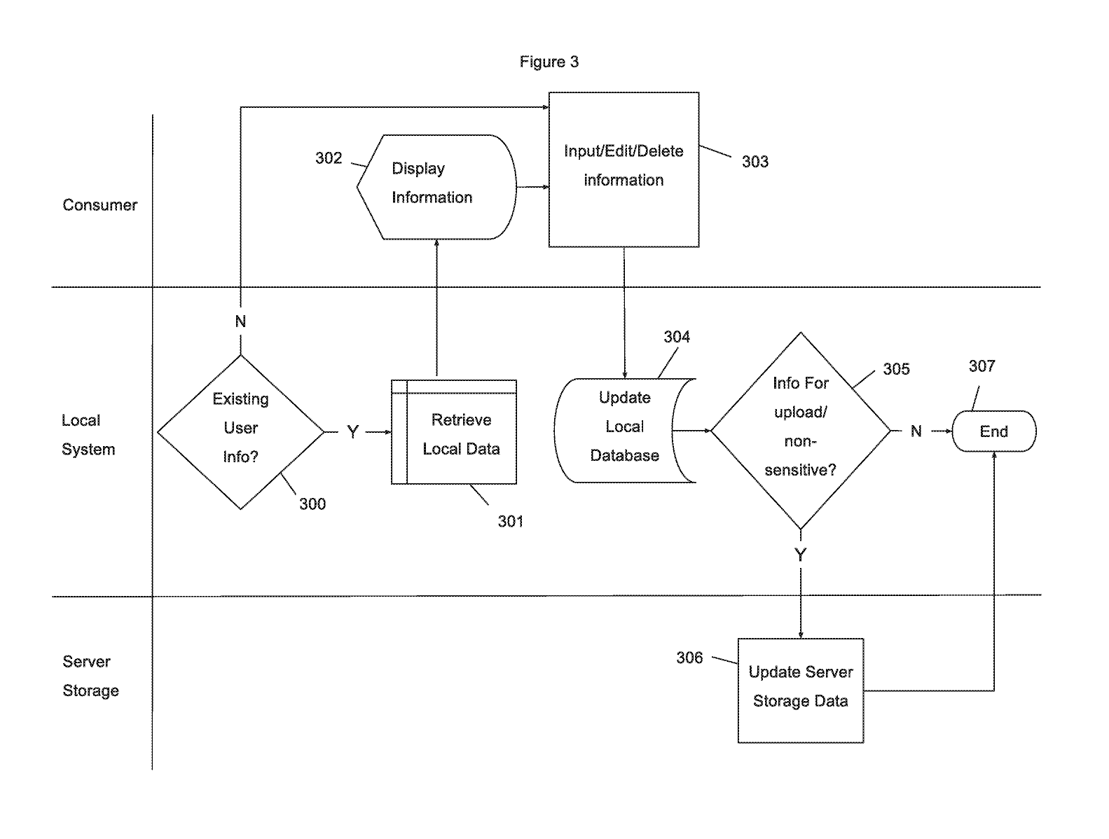

FIG. 3 depicts activities which might take place in the process of inputting, editing or deleting consumer information for renting and saving the information of the consumer in local storage and server storage.

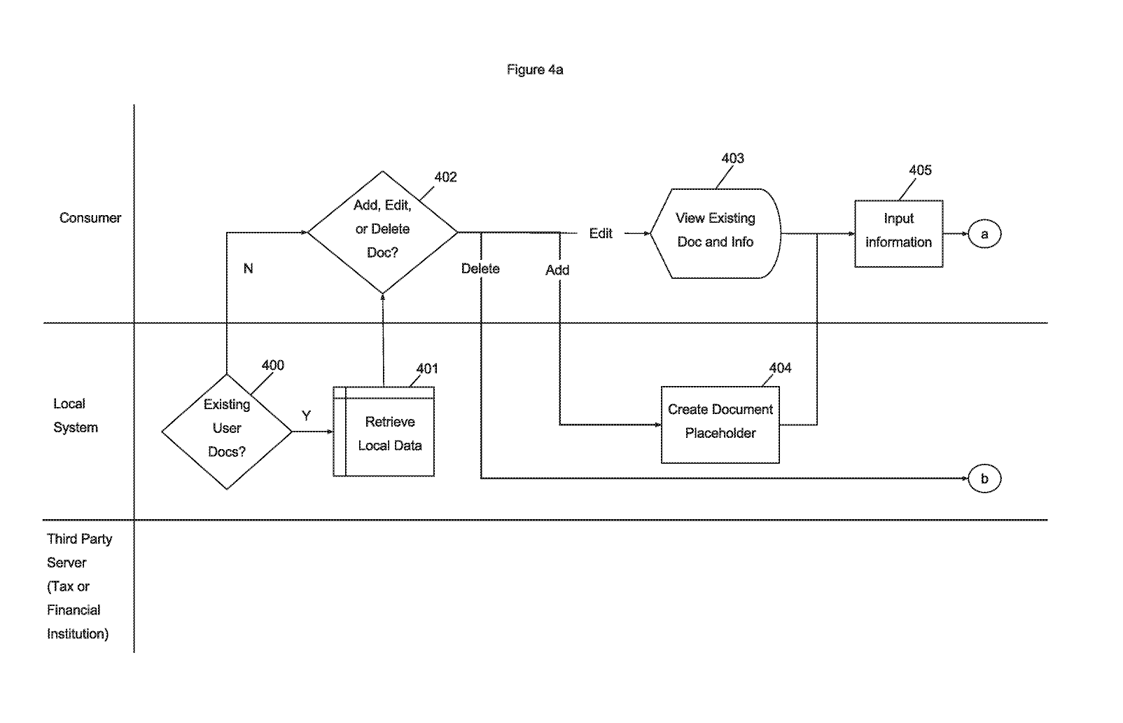

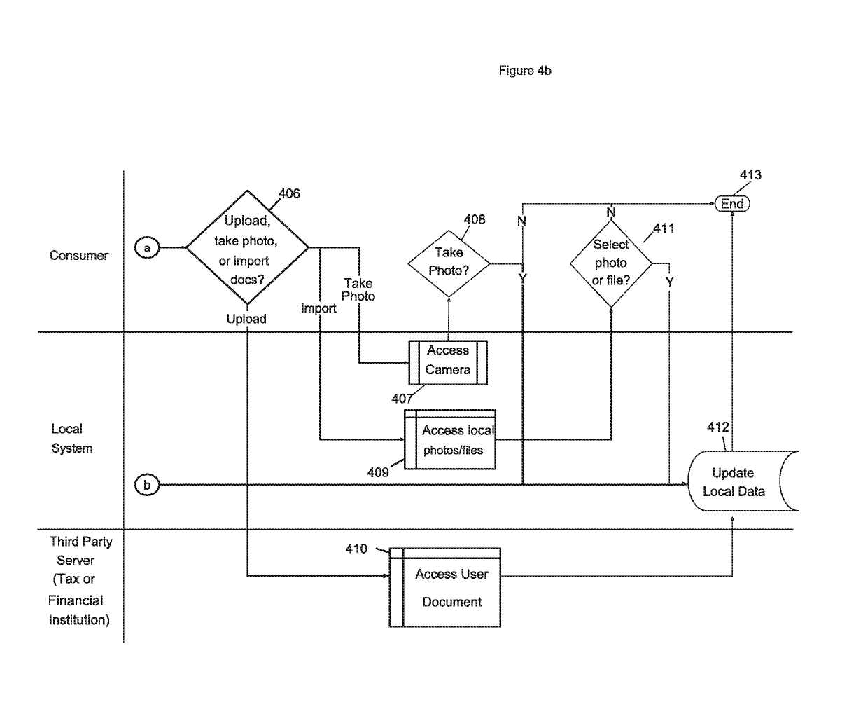

FIG. 4a-4b depict potential actions which might take place in the process of adding, editing or deleting consumer documents.

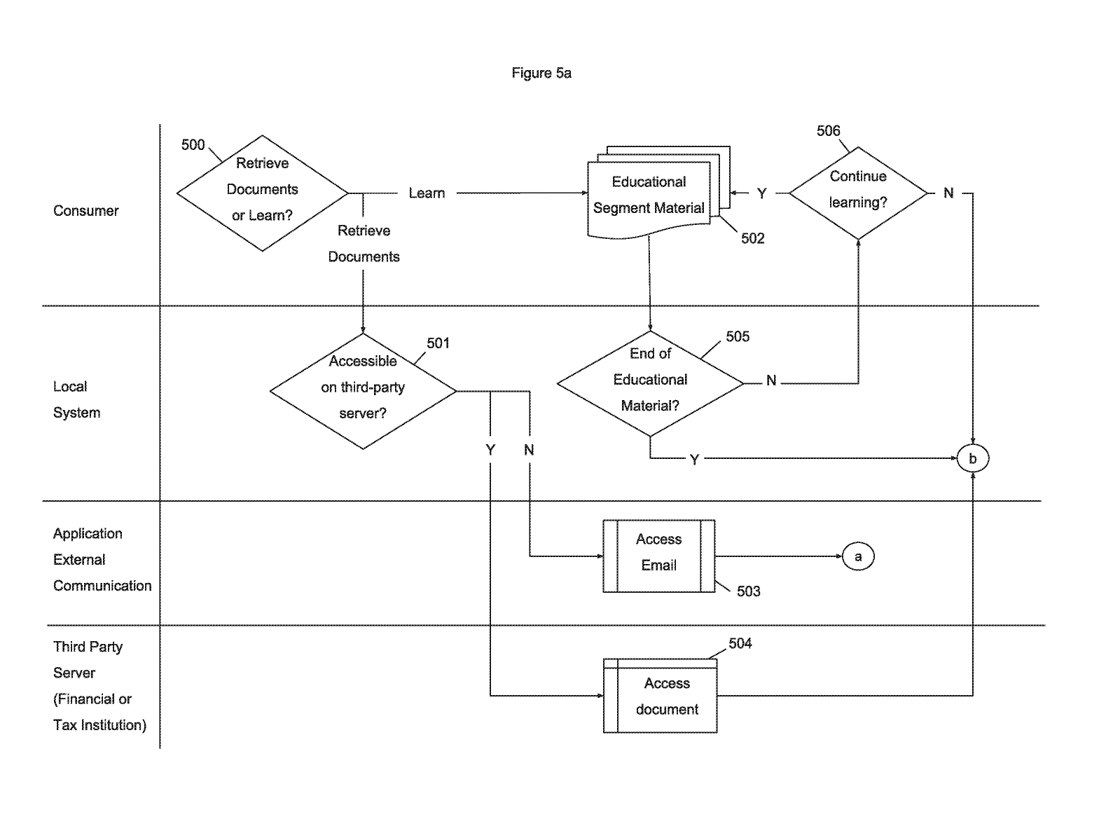

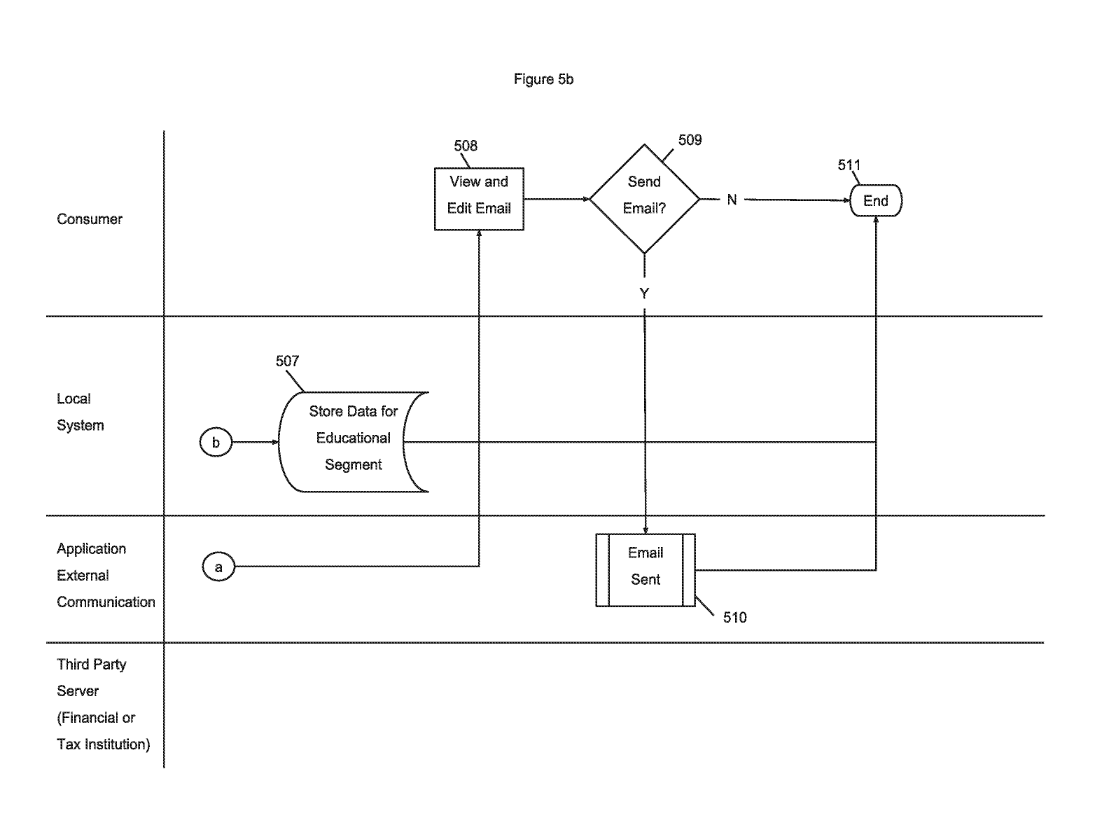

FIG. 5a-5b depict potential activities which might take place in the process of retrieving documents and learning about documents.

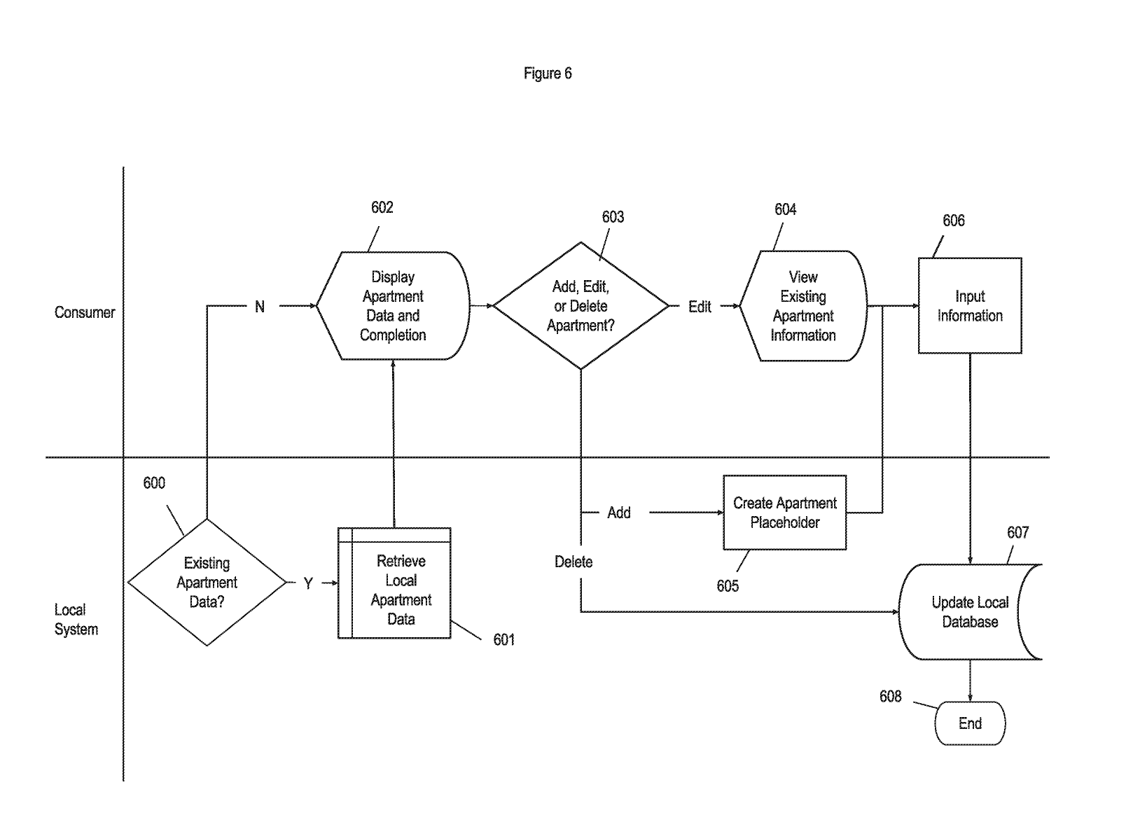

FIG. 6 depicts potential actions which might take place in the process of adding, editing or deleting apartments to create a consumer-generated apartment database.

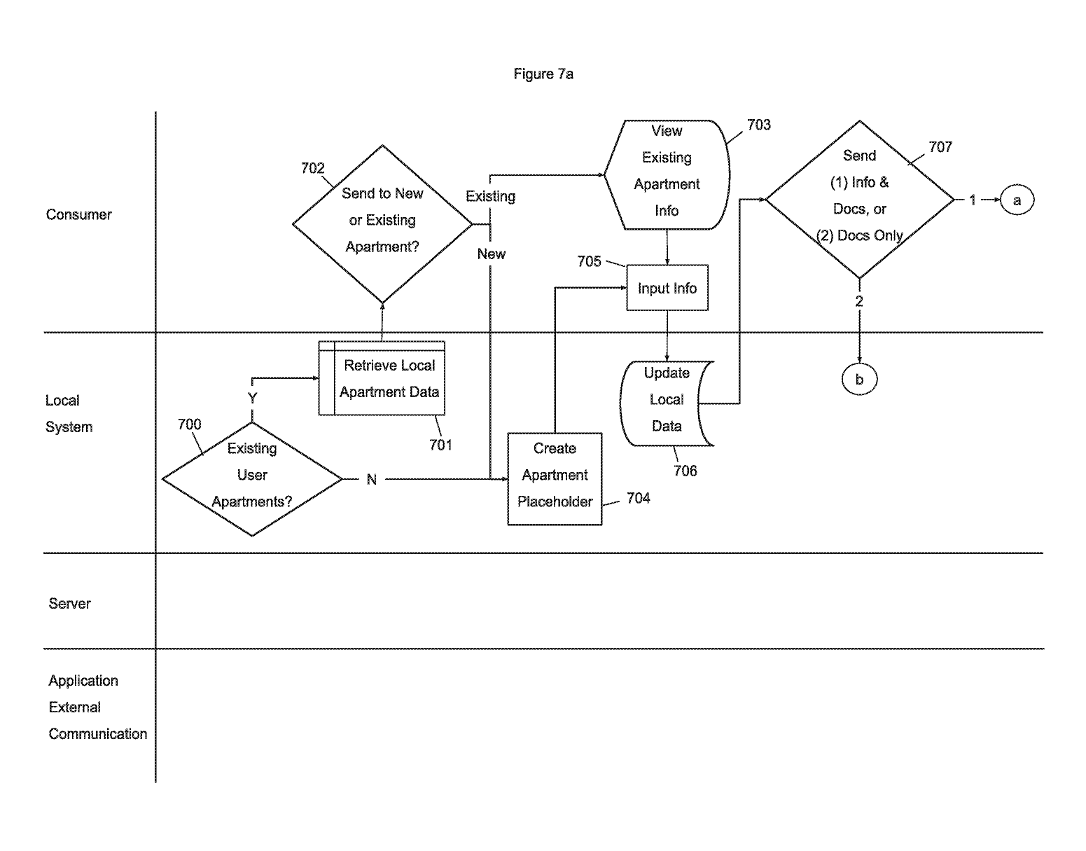

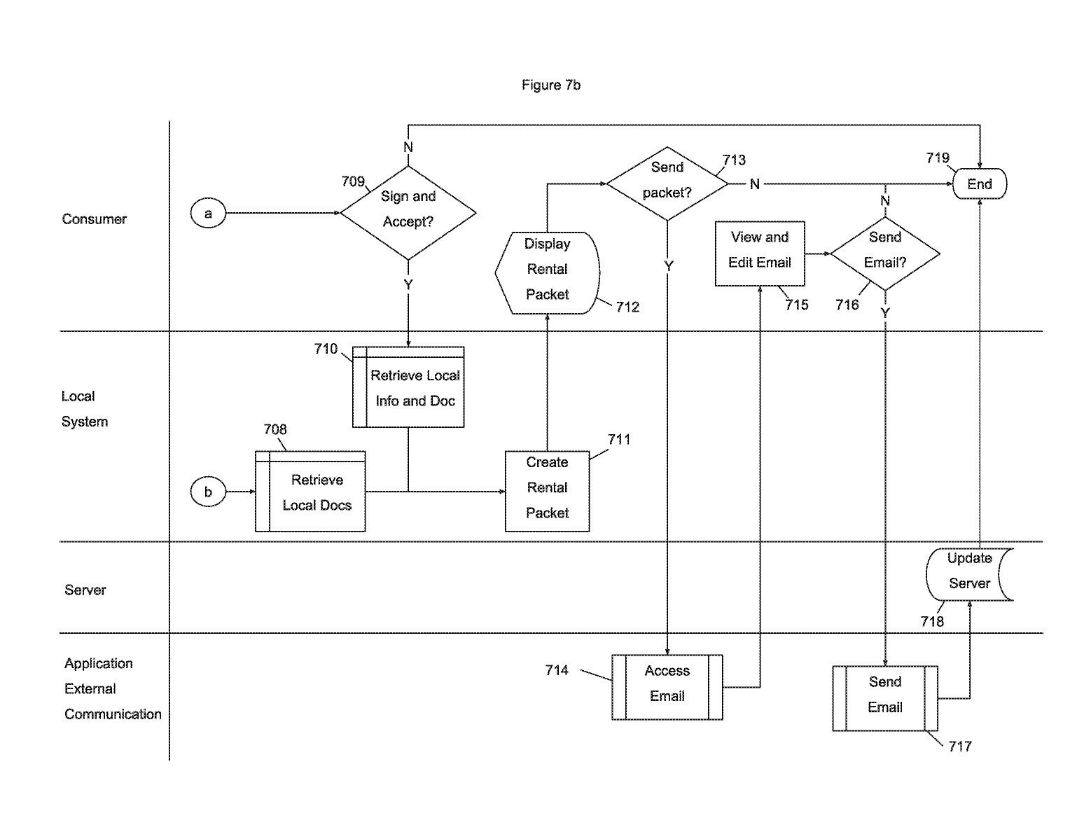

FIG. 7a-7b depict potential actions of selecting apartment and creating a rental packet that can be sent through external communication.

### DETAILED DESCRIPTION

In reference to FIG. 1, an exemplary architecture is provided for a system which could be implemented in accordance with one or more of the aspects described herein. Such a system can incorporate one or more devices, which can communicate with one or more servers [100], of which each can include one or more databases. Although there are multiple plausible implementations of such system, an example of a potential implementation could be based upon a one or more physical devices that would provide a local database for storage of sensitive documents and information (such as social security numbers, bank statements, tax returns, pay stubs, etc.), a means for transmitting information, as well as a main server connected to the internet with the ability to both store non-sensitive documents and information (such as vehicle information, education level, pet information, employment information, etc.) and support connection to the aspects described below. As depicted by FIG. 1, regardless of the specific setup, consumers [101], agents/landlords [100], and admin [102] may interact with mobile apps [104], websites [103], and/or custom apps (such as a desktop app, web app, etc.) [105], which each may interact with outgoing/incoming communication [107] as well as servers [Ω] that may connect to external parties such as screening companies [108], financial institutions [109], and tax services [110]. It is imperative to note that other architectures possible (such as those without a website and/or custom app, more than one server, servers which could store sensitive information, firewalls, one or more tiers of security, etc.) can be easily constructed in light of aspects disclosed herein, and thus is not limited to a single architecture. The multifarious interaction, processes, and communications which might occur, as well as their context, are described herein.

In reference to FIG. 2, an exemplary interface architecture is depicted for a system which can be used by a consumer to gather information and documents needed for the rental process and transmit such information and documents as a rental packet to one or more landlords/agents. The illustration depicted by FIG. 2 details four groups that could use the system through multiple interfaces, including a consumer interface (for users, individuals, or parties seeking to,obtain living accommodations) [200], an owner/agent interface (for users, individuals, or parties seeking to provide living accommodations) [204] and an admin (for users, individuals, or parties to designated to control the interfaces of other users) [202]. In some implementations, each group could be presented with a distinct interface to access the utility of each system. For example, in some implementations, a server [207] could allow for a mobile application, which can contain distinct pages that act as interfaces for multiple users, such as a consumer interface [201], a landlord/agent interface [203] and an admin interface [205]. Other implementations could include desktop or web applications as well as websites, which would also be connected to the aforementioned server, to allow multiple users to achieve the utility of gathering the information and documents needed to rent and transmitting the rental packet containing the information and documents as designated by the user(s). These different interfaces may be implemented as part of an interface module (as shown in FIG. 2) and may be able to communicate with each other as through a communication module [206]. It is possible that some implementations might not include a server such as a mobile application or custom application. There may be cases in which a customer, landlord/agent and an admin use a website or custom application rather than a mobile application. It should be noted that the description of interfaces and architecture of FIG. 2 are only illustrative, and not limiting.

In reference to FIG. 3, a diagram is depicted showing potential actions which might take place in the process of inputting, editing or deleting consumer information for renting and saving the data to local and server storage. The process begins with the local system determining if the consumer has existing information in local storage [300]. If the local system has existing information stored for the consumer [300], then the system retrieves the existing data [301] and then populates the related, necessary fields within the consumer's interface accordingly [302]. If the consumer does not have existing information stored for the consumer [300] or once the existing information is displayed [302], then the consumer could choose to input, edit or delete information [303]. After inputting, editing or deleting information [303], the information could be updated to local storage [304]. The local system could determine if the information is to be considered sensitive or nonsensitive [305]. If the local system determines that the information is non-sensitive, then the server storage may be updated with the nonsensitive information [306] and then the process ends [307]. If the local system determines that the information is sensitive, then the process terminates without saving the information to the server storage [307].

In reference to FIG. 4a-4b, diagram are depicted showing potential actions that might take place In the process of adding, editing and deleting documents necessary to rent. The process could begin with the local system observing if the consumer has existing documents [400]. Alternatively, if the consumer has existing documents, the system may retrieve the existing data [401] and then allow the consumer to choose to add, edit or delete documents [402]. If the consumer does not have existing documents, the consumer may only be able to choose to add documents [402]. If the consumer chooses to add a document [402], the local system could create a document placeholder [404]. If the consumer chooses to edit a document [402], the consumer may view the stored document and associated information [403]. Once an existing document and information are displayed [403] or a document placeholder is created [404], the consumer may input information for the necessary document [405] and then choose to import, upload or take a photo of a document [406]. If the consumer chooses to take a photo, the local system could access the local system's camera [407]. If the consumer takes a photo, the photo may be saved to a local database [412]. If the consumer chooses not to take a photo [408], then the process ends [413]. If the consumer chooses to upload a photo or file [406], then the local system may access the local photos and/or files [409]. If a photo or file is chosen by the consumer [411], the local system may save the chosen photo or file to local database for documents [412]. If the consumer chooses not to select a photo or file [411], then the process ends [413]. The consumer may also choose to import a file from a third party external server [406], in which case the server could be accessed [410] and the file may be saved to a local database [413].

In reference to FIG. 5a-5b, diagrams are depicted showing potential actions that might take place in the process of retrieving or learning about documents. The process may begin with the consumer choosing to either retrieve or learn about documents [500]. If the consumer chooses to retrieve documents, the local system determines if the document is accessible on a third party server [501]. If the document is not accessible [501], then the consumer's email is accessed [503] and the consumer may view and edit the email [508]. If the consumer chooses to send the email [509], the external application communication sends the email [510]. If the consumer chooses not to send the email [509], then the process ends [511]. Alternatively, if the document is accessible [501], the document may be retrieved [504], saved onto local storage [506], and the process ends [511]. The consumer may choose to learn about documents [500], and then the consumer may be directed to the educational segment documents [502]. After each document of the educational segment is completed [502], the local system may check if the end of the educational segment documents has been reached [505]. If the end has not been reached [505], then the user may choose to continue learning or not [606]. If the user chooses not to continue learning [506] or if the local system determines that the end of the educational segment documents has been reached [505], then the local system may store the completion data for the educational segment [507] and the process ends [511].

In reference to FIG. 6, a diagram is depicted showing potential actions that might take place in the process of adding, editing or deleting apartments to storage. The process may begin with the local system determining if any locally stored apartment data is found [600]. If the system determines that locally stored data exists [600], then the local system retrieves the stored apartment data [601] and then displays the apartment data to the consumer [602]. Once the apartment data is displayed [602] or the local system determines that no apartment data exists [600], then the consumer may choose to add, edit or delete apartments [603]. If the consumer adds an apartment [603], the local system may create an apartment placeholder [605]. If the consumer edits apartment information [603], the consumer may view existing apartment details [604]. Once an existing apartment is viewed [604] or an apartment placeholder is created [605], then the consumer may input information to update the apartment details [606], the local system may update the locally stored data, [607] and the process ends [608]. If the consumer deletes apartment information [603], then the local system updates locally stored data [607] and the process ends [608].

In reference to FIG. 7a-7b, diagrams are depicted showing potential actions that might take place in the process of selecting or creating an apartment and creating a rental packet that can be sent through external communication. The process may begin with the local system determining if the local storage has existing apartment data [700] and retrieving any existent apartments from the local database [701]. The consumer may then choose to select an existing apartment from local storage or creating a new apartment [702], for which the rental packet will be sent. If the consumer selects an existing apartment, the apartment data may be displayed to the consumer [703]. If the local system determines that no apartment data exists [701] or the consumer chooses to send the rental packet for a new apartment [702], then the local system may create a new placeholder apartment [704]. Once the existing apartment information is displayed to the consumer [703] or a new apartment placeholder is created [704], the consumer may input and edit information about the apartment [706]. The entered information may then be updated in the local database [706] and then the user may choose to send their information and documents, or documents only [707]. If the consumer chooses to send information and documents, then the consumer may choose to sign and accept the terms of the rental packet [709]. If the consumer does not sign and accept terms, then the process will end [720]. Alternatively, if the consumer does sign and accept the terms [709], then the idea system may retrieve the local information and documents [710] and create a rental packet [711]. If the consumer chooses to send only documents [707], then the local system may retrieve the consumer's documents from a local database [708] and create a rental packet [711]. Once a rental packet is created [711], the rental packet is displayed to the consumer [712] and the consumer may choose whether or not to send the packet [713]. If the consumer chooses not to send the packet [713], then the process will end [719]. Alternatively, if the consumer chooses to send the packet [713], then application's external communication will be accessed [714] and the consumer will be able to view and edit the email [715]. The consumer may choose whether to send the email or not [716]. If the consumer chooses not to send the email, the process will end [719]. Otherwise, if the consumer chooses to send the email, the application's external communication may send an email to the agent, landlord, or other individual or party [717], designated in the previously entered apartment-specific information [704], and the server updates with information about the information sent [718] and the process ends [719].

1. A system comprising of one or more computer processors, configured with executable instructions which, when executed, will cause the one or more computer processors to perform a plurality of tasks comprising: A) generating, formatting, and sending a consolidated packet to an owner, agent, or other individual or party of the renters choosing. B) providing the consumer a method, whether through email or other, for transmitting this packet of information and documents. C) upon transmission of the information and documents, notifying and providing access to view and retain information and documents to a specified individual, property owner, manager, or agent. D) providing the consumer a method and memory to persistently store rent-specific information and documents.

2. A non-transitory computer medium capable of receiving and persistently storing renter-specific information required in order to rent an apartment from an owner or through an agent This information may encompass renter-specific details such as personal information, current address, residence history, education, identity, criminal history, pet information, emergency contact, references, additional occupants, bank information, current employment, prior employment, vehicle information, desired apartment characteristics, and guarantor information, where applicable.

3. The non-transitory computer medium of claim 2, wherein the system tracks completion of the renter's input of necessary information, permitting renters, agents, and/or owners to visualize the progress of renter-specific details either by categorization or in totality.

4. A non-transitory computer medium capable of a plurality of tasks comprising: A) persistently storing documents required in order to rent an apartment from an owner or through an agent. These documents may include, but are not limited to, documents about the renter and/or the guarantor of the renter such as letters of employment, pay stubs, bank statements, tax returns, W-2and related tax forms, student transcripts, credit reports, background checks, and supporting documentation that aids in the judgment of the qualification and ability of a renter to successfully uphold payment and tenancy of an apartment, where applicable. B) receiving documents via the renter taking a photo of the document, uploading the document from a photo library, or importing the document from a third-party source, which may include financial institutions, tax agencies, the internal revenue system, employers, educational institutions.

5. The non-transitory computer medium of claim 4, wherein the system tracks completion of the renter's input of necessary documents, thus allowing renters, agents, and/or owners to visualize the progress of renter-specific document either by categorization or in totality.

6. The system of claim 1, wherein the plurality of tasks comprises: A) dynamically transmitting educational segments on how, why, and what renters must obtain to enable the completion of the information and documents described in claims 2 and 4. B) generating communication with third parties to obtain necessary information and documents such as W-2's, pay stubs, or letters of employment. C) providing renters with specific directions on how to and/or access to retrieve bank statements and/or tax returns.

7. A method using a computer comprising a processor and memory to: A) engender and present related to renters based on the renter-specific information and documents described in claim 2 and claim 4. B) multifarious notifications wherein renters can elect for notification of upcoming payments, including rent, utilities, internet, cable, and similar services. C) automatically complete, either partially or wholly, additional third-party forms using the information and documents described in claim 2 and claim 4, while permitting additional supplemental information and documents to be entered and persistently stored in the related non-transitory computer medium described in claims 3 and 5.

8. A non-transitory computer medium capable of a plurality of tasks comprising: A) receiving and persistently storing a renter-generated database of apartments and/or residencies of interest, of which such information may include the address and unit number (if applicable), proposed monthly rent, desired start date for renting, lease length, renter and guarantor application fees (where applicable), payment method(s) and associated details, selected information and documents from claims 2 and 4 to be sent as described by claim 11, and the owner(s) and agent(s), along with subsequent contact information.

9. The non-transitory computer medium of claim 8, wherein the system tracks completion of the renter-generated database, permitting renters, agents, and/or owners to visualize the progress of renter-specific details either by each individual apartment or in totality.

10. A system comprising of one or more computer processors configured with executable instructions which notify renters, agents, and/or owners of additional features, offers, or messages based on information and documents in profile.

11. The system of claim 1, wherein the plurality of tasks comprises: A) generating, formatting, and sending a consolidated packet to be sent to an owner, agent, or other individual or party of the renter's choosing. B) enabling the renter, agent, or owner specification of the content of the consolidated packet to include selected portions or the entirety of the renter's information and/or documents described in claims 2 and 4.

12. The system of claim 1, wherein the plurality of tasks comprises electronic signing and authorization any necessary payments, including fees for background and credit checks, security deposits, and rent.
